(19) United States
(12) Patent Application Publication
(10) Pub. No.: US 2017/0303369 A1
(43) Pub. Date: Oct. 19, 2017

(54) SYSTEMS AND METHODS FOR LIMITING INRUSH CURRENT

(71) Applicant: Biological Innovation & Optimization Systems, LLC, Melbourne, FL (US)

(72) Inventor: Eric Thosteson, Satellite Beach, FL (US)

(73) Assignee: Biological Innovation & Optimization Systems, LLC

(21) Appl. No.: 15/482,929

(22) Filed: Apr. 10, 2017

Related U.S. Application Data
(60) Provisional application No. 62/323,004, filed on Apr. 15, 2016.

(51) Int. Cl. H05B 33/08; H02M 1/32; H02J 9/06; A01G 9/20; H05B 37/02; A01G 7/04

(52) U.S. Cl. CPC H05B 33/0887; H05B 37/0281; H05B 33/0857; A01G 7/045; H02J 9/06; A01G 9/20; H02M 1/32

(57) ABSTRACT

Systems and methods for limiting inrush current spikes in multi-load systems are disclosed. Inrush current limiting modules according to some embodiments comprise programmable microcontrollers and logic activated switches that connect loads to main power in a staggered and non-simultaneous manner thereby limiting inrush current spikes. Applications include agricultural grow systems employing multiple grow light fixtures and other high power and multiple load systems. Programmable logic controlled switching mechanisms operating under reserve power and integrated into power supplies are also disclosed.

### RELATED APPLICATIONS

This application claims priority to and the benefit of U.S. Provisional Application No. 62/323,004, filed Apr. 15, 2016, the contents of which are incorporated herein in their entirety.

Except to the extent that any of the disclosure in the referenced patents conflicts with the disclosure herein, the following US patents, which include inter alia disclosure pertaining to light emitting diode (LED) luminaires and light engines, LED driving and switching methods, LED power supplies and inrush current limiters are incorporated herein by reference in their entireties: U.S. Pat. Nos. 6,335,654, 6,714,429, 8,749,163, 5,930,130 and 8,749,160.

### FIELD OF THE INVENTION

Embodiments of the invention relate to a systems and methods for limiting inrush current in AC/DC and DC/DC power supplies applications including embodiments and applications in the field of LED luminaire and LED grow lighting and LED grow fixtures.

### BACKGROUND OF THE INVENTION

Light emitting diodes (LED) technology is rapidly being applied to the agricultural and horticultural fields to allow for high efficiency indoor plant cultivation and growth. The increased energy efficiency of LED technology compared with other lighting solutions coupled with the reduction of costs of LED themselves are increasing the number of LED applications and rate of adoptions across industries. Examples of such industries and markets include plant growing applications spanning the breadth from small indoor home greenhouses and nurseries to full scale indoor farming facilities. LEDs and associated technologies are becoming increasingly electrically efficient and ate supplanting other lighting technologies because of this efficiency and associated cost savings. LED technology also promises greater reliability overall lifetimes than other lighting technologies. Importantly, LED technology and solid state lighting (SSL) in general provides a platform to customize specific light output spectra to meet the demands of any specific application thereby increasing efficiency and optimizing the light output to meet the desired application. This feature of tailoring and tuning output spectra of LED fixtures can be used in grow lighting and other areas to provide the specific wavelengths and wavelength ranges tailored and, optimized to the specific application. For example, with respect to grow lighting optimization of photo-synthetically active regions of the light spectrum depending on the plant species and/or growth cycle can both reduce energy consumption and enhance growth and yield.

As is well known in the art, LED fixtures may comprise individual LEDs or multiple LEDs arranged in electrical connection (e.g., series or parallel) and which are powered by an LED driver or power supply. Examples of these power supply (PS) drivers include AC/DC and DC/DC switched mode power supplies (SMPS). These SMPS may be designed to supply constant current to the LED string in order to maintain and consistent and steady light output by the LEDs. Typically the SMPS receives and transfers power, after conditioning it, from the AC mains power, to a LED load.

An LED grow light fixture typically has its own power supply unit that is directly connected to the AC mains (e.g., hard-wired). An LED grow fixture typically has relatively large power supply, for example one capable of providing 500-1000 W of steady state power. In a typical grow facility there may be 100 fixtures or more, each with its own dedicate power supply, and which are all wired to the same source or AC mains power. In this case, the grow light fixtures share the same circuit such that power delivered to the fixtures is controlled by a central switch such that all the fixtures may be energized and turned on via a single switch simultaneously. This configuration of multiple power supplies connected to a single source of power and controlled by a central switch gives rise to a significant problem of inrush current, which will now be described.

The problem of in-rush currents is well known and can arise in a variety of circuit topologies including those that employ large inductors or transformers such as motors and those that employ large capacitors. Inrush current also known as input surge current or switch-on surge is the maximum, instantaneous input current drawn by an electrical device when first turned on, i.e., connected to the power source. Because power supplies typically contain bulk capacitors, they are particularly susceptible to inrush current. During power-up of an individual power supply, a large inrush current flows when the input capacitors are suddenly charged. If unrestricted, the in-rush current can easily exceed 50 A sometimes approaching 100-150 A at the peak of the AC cycle. The large inrush current may severely stress the power converter's fuse and input rectifiers—significantly reducing the reliability and life expectancy of the modules or cause immediate power failure. The inrush current may also limit operation of other power devices on the line and other components including the power line, switched, relays, circuit breakers, etc.

The problem of in-rush current becomes increasingly magnified when a plurality of in-rush susceptible loads exist on a single circuit supplied by a central source of power (e.g., AC Mains). For example, if the peak inrush current for a single SMPS when connected to the main power is 50 amps, a group of 20 such SMPS connected to a single power source would result in an inrush current in excess of 1000 A. This magnitude of initial current would likely damage circuit components and degrade their performance causing premature failure.

Known solutions to limit inrush current typically require resistors or conventional negative temperature coefficient (NTC) thermistors. A thermistor is a thermally-sensitive resistor with a resistance that changes significantly and predictably as a result of temperature changes. Use of thermistors however contribute to significant power loss and decrease in electrical efficiency and are therefore not the optimal solution when energy efficiency is an important consideration.

Applications of indoor grow facilities include the use of many LED grow light fixtures, each of which is connected to the AC mains power and the multiple grow light fixtures may be controlled by a single switch. A single switch (or limited number of switches) allowing the energizing of the all the fixtures at once through a single (or limited number of) interface and is very convenient.

Typically each LED light fixture has its own dedicated onboard power supply, for example, a switched mode power supply (SMPS). Although the description embodiments herein may refer to specific types of power supplies, e.g., SMPS, the invention is not limited to SMPS and will be applicable to any power solution where significant inrush current is a concern. This arrangement causes a significant problem of in-rush current when the main switch is operated to connect the AC mains power to all or a large number of or multiple fixtures simultaneously. Because the in-rush current for each fixture may be as much as or even exceed 100 amps, multiple fixtures energized simultaneously via a central switch may result in an inrush current of several thousand amps. This large current can have adverse effects on the circuit in general and switch in particular causing a failure of one or more components and sub optimal performance. This spike can destroy and degrade circuit elements including fusing the main switch and elements of the lighting fixture itself. When the main switch is closed, each of the dedicated power supplies is seen by the circuit as a load and a current sink, causing a large inrush current or current spike which can damage the switch and other circuit elements.

Although typically each fixture is connected to the same AC mains circuit through a single circuit breaker or switch, other arrangements including multiple lines and multiple mains switches may also give rise to a significant and unwanted in-rush current.

FIG. 1 illustrates schematically how LED grow lighting fixtures are conventionally connected to a power source. The LED grow fixtures 150 typically comprise a number of components including an LED power driver 160, one or more LED boards or light engines, and, heat sinks and other ancillary components (not shown). LED grow light fixtures 150 each containing their own LED driver or power supply 160 are connected to a common circuit supplied by AC mains power and being controlled by a main power switch 110. When the mains switch is closed, each LED lighting fixtures act as an instantaneous load in the circuit drawing power from the main. This simultaneous loading results in large and damaging in-rush current spikes that may stress and damage circuit elements. An inrush current limiter (not shown) such as a NTC thermistor may be used inline or incorporated into the LED driver. Although the thermistors may attenuate the current spike somewhat, they reduce the electrical efficiency of the system. As shown in the figure, multiple LED fixtures may be connected to the to the main power; the greater the number of fixtures, the greater the potential in-rush current.

### BRIEF SUMMARY

Embodiments of the invention include methods for limiting or attenuating inrush current spikes when simultaneously connecting multiple loads to a main electrical power source comprising the steps of receiving an electrical power signal at a first controller associated with a first load wherein said first controller controls a switching means for connecting said electrical power signal to said first load, generating a first time delay, and after the first time delay, activating a switching means for connecting the electrical power signal to the first load thereby electrically energizing the first load. Embodiments include receiving said electrical power signal at a second controller associated with a second load wherein said second controller controls a switching means for connecting said electrical power signal to said second load, generating a second time delay, and after the second time delay, activating a switching means for connecting the electrical power signal to the second load thereby electrically energizing the second load. In some embodiments, said first controller generates said time delay upon receiving said electrical power signal, compares said time delay to an elapsed time, determines when said first time delay has completed and activates said switching means to electrically energize said first load.

Additional embodiments include methods for limiting or attenuating inrush current spikes comprising the steps of receiving an electrical power signal at a controller associated with a first load, a second load and a third load, wherein said controller controls a switching means for connecting said electrical power signal to said first, second and third load, generating a first time delay, a second time delay and a third time delay and after the first time delay, activating a switching means for connecting the electrical power signal to the first load thereby electrically energizing the first load, and after the second time delay, activating a switching means for connecting said electrical power signal to a second load thereby electrically energizing the second load and, after the third time delay activating a switching means for connecting the electrical power signal to a third load thereby electrically energizing the third load, and wherein said controller generates said first, second and third time delays upon receiving said electrical power signal, compares said time delays to an elapsed time, determines when said first, second and third time delays have completed and activates said switching means to electrically energize said first, second and third loads respectively.

Additional embodiments include methods as described above wherein one or more time delays are randomly generated by the controller. In some embodiments, the time delay interval is less than about 500 ms. In other embodiments the time delay interval is less than about 200 ms. In other embodiments the time delay interval is less than about 50 ms. In still other embodiments the time delay interval is less than about 20 ms. In some embodiments, the time delays are uncorrelated; in other embodiments the time delays are unique.

In some embodiments the switching means comprises an electrical relay and the electrical power signal is delivered by the AC power mains.

In some embodiments, the loads comprise LED grow light fixtures. In some embodiments a load comprises a power supply and the power supply comprises a controller.

Additional embodiments include a circuit element for connecting an electrical power signal to a load while limiting or attenuating inrush or current spikes to the load comprising a power conditioner, electrical switching means for connecting an electrical power signal to a load, a microcontroller that, upon receiving an electrical power signal, generates a time delay interval, and at the end of the time delay interval controls the electrical switching means to connect the electrical power signal to the load thereby electrically energizing the load, and a reserve power means for providing electrical power to the microcontroller. In some embodiments, the electrical switching means comprises an electrical relay or solid state switch. In some embodiments, the microcontroller is programmable and in some embodiments the microcontroller generates random time delay intervals upon receiving the electrical power signal. In some embodiments, the circuit element comprises a reserve power source.

Additional embodiments include a power supply with integrated switching means operable to limit or attenuate inrush current spikes when connecting the power supply to main power comprising, an input means for receiving electrical power, a power conditioner, a logic controlled switching mechanism for delaying when main electrical power, received via said input means, is connected to the portion of the power supply downstream from said switching mechanism, and an output means for delivering conditioned power to a downstream electrical load. In some embodiments, the power supply is a DC power supply and in some embodiments it is a switched mode power supply.

In some embodiments, the power supply includes a logic controlled switching means comprising a programmable microcontroller that initially delays connecting received main electrical power to the downstream portion of the power supply by generating a time delay interval upon receiving the main electrical power, waiting for a time period equal to the time delay interval, and then operating a switching means to connect the received main power to the downstream portion of the power supply. In some embodiments, the logic controlled switching means comprises an electrical relay or solid state switch. In some embodiments, the power supply further comprises a reserve power means for operating said microcontroller in the absence of main power, and the power conditioner comprises and AC/DC converter.

### BRIEF DESCRIPTION OF THE DRAWINGS

FIG. 1 is a schematic diagram showing how LED lighting fixtures are conventionally connected to power mains.

FIG. 2 illustrates a schematic view of the in-rush current limiter system and method according to some embodiments.

FIG. 3 shows a process flow of the logic controlled switching mechanism of the in-rush current limiting method and system according to some embodiments.

FIG. 4 is a block diagram of in-rush current limiting module according to one embodiment

FIG. 4 is a block diagram of in-rush current limiting module according to one embodiment.

FIG. 5 is a block diagram of an in-rush current limiting module according to another embodiment.

FIG. 6a shows a block diagram representing an inrush current limiting module (IRCLM) according to some embodiments.

FIG. 6b illustrates schematically a multi-load electrical system employing inrush current limiting modules (IRCLMs) according to some embodiments.

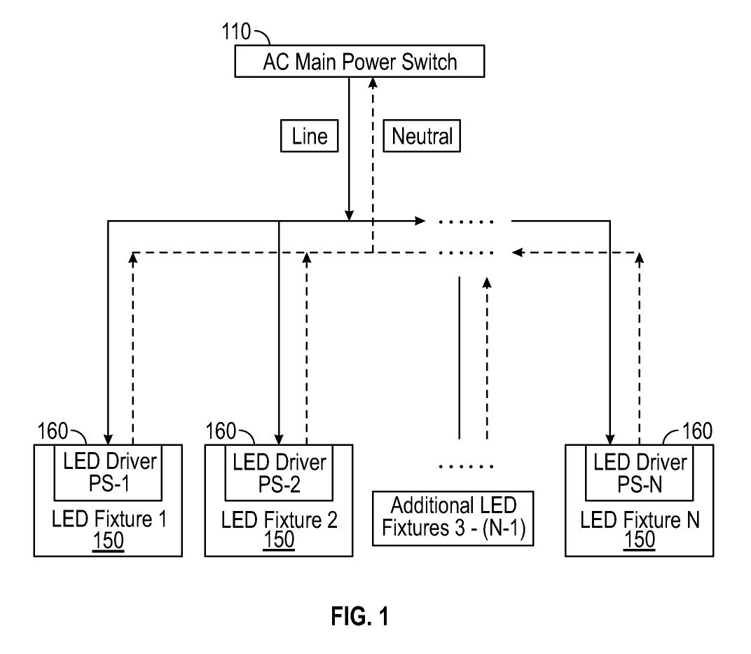

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

In one embodiment, a novel solution of in-rush current limitation and protection is provided to a situation where multiple devices, each comprising its own DC power supply, all are connected to a single power mains. One of the significant causes of the large magnitude of in-rush current is due to the fact that all power supply loads on the main line are connected to the power mains and energized simultaneously or nearly so. This simultaneous loading produces a large current sink causing a transient in-rush current spike. Embodiments of the invention include methods and systems for avoiding and/or attenuating the transient current in-rush spike by preventing the simultaneous current demand from each power supply when the mains switch is closed. In order to reduce, mitigate or prevent the current in-rush due to simultaneous energizing of the fixture power supply drivers, a method of staggering or delaying the instantaneous current draw of each of the fixtures is employed. In some embodiments an additional switching mechanism for each fixture is implemented to slightly delay the energizing of that fixture. Because the in-rush current spike is a transient phenomenon that occurs only within the initial moments of the main circuit being energized, being due to the simultaneous and current sinking of all the loads on the circuit, embodiments of the invention that prevent this simultaneous loading and current sinking upon the application of mains power provides a solution to and prevention of damaging in-rush current as will be described more fully below. Methods of limiting the current inrush that occurs when multiple fixtures are connected to a power mains source can be accomplished in a number of ways. Example embodiments are shown in the referenced figures and description that follows herein. In the description herein, references to an LED driver or LED power supply or LED fixture are used throughout and it is understood that these terms are sometime used interchangeably when referring to applying or connecting power thereto.

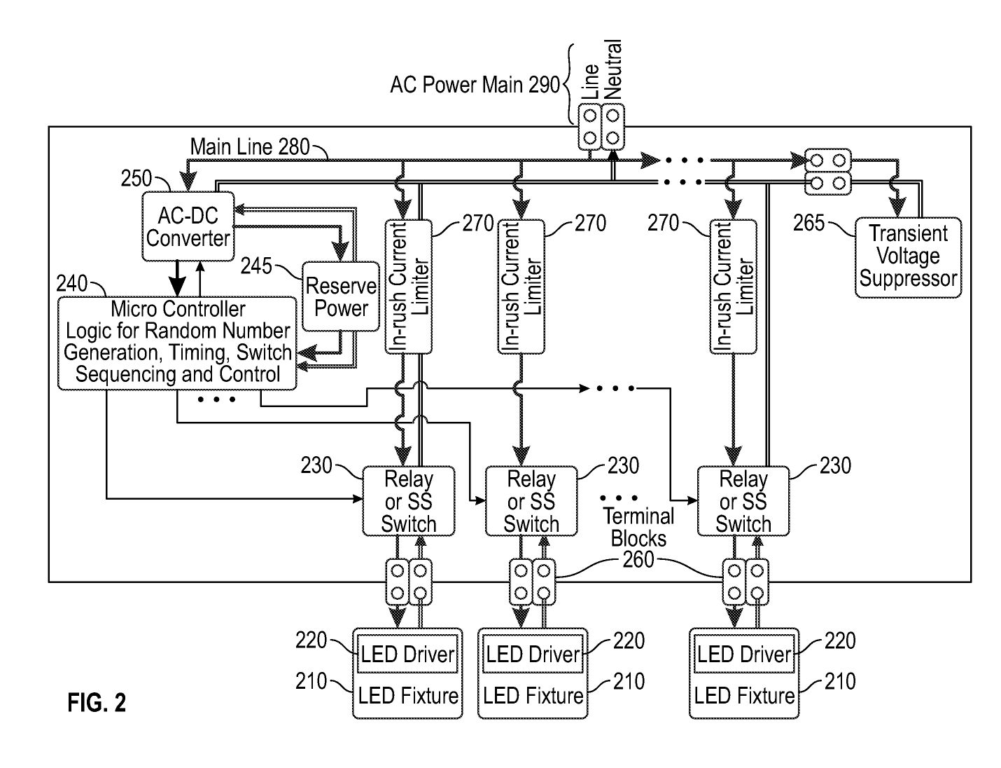

FIG. 2 shows a schematic diagram illustrating one embodiment of the invention. In this embodiment, large in-rush currents are attenuated or eliminated by preventing the simultaneous connection and current draw of all the LED fixture on the circuit. In this embodiment, an additional switch (e.g., relay) is used with each fixture to control current flow to that fixture. Each of the switches is controlled by a separate microcontroller (e.g., a microprocessor or integrated circuit). When the mains switch is closed, no current flows to the fixture until the microcontroller switch associated with each fixture is closed. Once energized by the main power circuit, each microcontroller generates a time delay interval and at the completion of the time delay interval, signals and closes the switch, allowing main power to flow to the individual fixture. The time delay intervals generated by each controller are uncorrelated and generally (though not necessarily) all different short time intervals. In this arrangement, each fixture is connected to the main power at a slightly different times. These slight variations in the timing, of when each LED fixture is connected and appears as a load on the main power circuit, implemented by the controller-relay combination thereby prevents large in-rush current spikes by preventing simultaneous current draw from each power supply driver at the time the power main is connected.

Referring again to FIG. 2, multiple LED lighting fixtures 210, each associated with its own LED driver or power supply 220, are connected to a single main power source, in this example an AC power main 290. The main line 280 is connected to each lighting fixture power driver to provide power thereto. An optional in-rush current limiter 270 is shown in series with each fixture and driver and may be employed in each to provide additional current inrush protection. Examples of in-rush current limiters include but ere not limited to negative temperature coefficient (NTC) thermistors.

The novel in-rush current limitation solution provided by this embodiment of the invention is accomplished by a logic controlled switching mechanism comprising a relay or solid state switch 230 that is in line with each fixture 210 and power supply 220 and a microcontroller 240 that controls each switch/relay 230 as shown. The configuration of the relay/switch (i.e., whether it is in an opened or closed position) controls whether power from the mains is available to flow to the individual fixture power driver as will be described below. In some embodiments, the initial and default position of the relay/switch is in the open position. In these embodiments, the microcontroller 240 controls each of the relays/switches independently. For example, and as described further herein, when the power main switch is closed, main power is received by the microcontroller, and in response the microcontroller independently closes each of the relay/switches 230. The independent closing of each of the switches is done at slightly different times such that large inrush currents are prevented. An optional terminal block 260 to provide connection between the LED driver and relay/switch may be used depending on the application. According to some embodiments, an AC-DC converter or other power conditioner 250 converts mains power to appropriate DC power for the microcontroller. An optional transient voltage suppressor 265 is shown and may be used (but is not required), which functions to shunt to ground any large voltage or current spikes that might negatively impact the electrical system. A main power switch (not shown) is used to open and close the electrical connection between the power mains and the LED light fixtures.

The power supply 220 of each fixture 210 is typically designed to optimize the performance of the fixture, including for example light output, electrical efficiency and thermal characteristics, and may depend on a variety of fixture attributes, including number of LEDs, power requirements, power sources, form factors, etc. In these embodiments, the terms LED driver and LED power supply are used interchangeably. The power supply 220 may be custom designed and built or alternatively be sourced “off the shelf” and integrated into the LED lighting fixture. LED drivers and power supplies are well known in the art, and there is no limitation on the type of power supply used and the applicability of embodiments of the invention thereto. The AC power main may be, but is not limited to, conventional power mains including sources of power providing typically between 100-300 V. Although a single circuit is shown for the purposes of illustration, it will be understood that more than one circuit and associated circuit switching means may be used in connecting multiple LED lighting fixtures; the invention embodiments are in no way limited or restricted to a specific number of circuits. Furthermore, while the source of power in this embodiment is an AC power main, embodiments of the invention are not limited to any specific power source and other sources of power including direct DC power may also be used.

In one embodiment, when the mains switch is closed (mains power connected), the microcontroller 240 of the logic controlled switching mechanism receives a power signal from the main line. According to some embodiments, the power signal is conditioned by the AC-DC converter or other power conditioner. Initially, each of the controlled relays/switches remains open and no power may flow to the LED power drivers 220 and fixtures 210. In some embodiments a single microcontroller controls multiple relays or switches thereby controlling when power is delivered to multiple fixtures. In other embodiments, the relay or switch to each individual power load (e.g., light fixture) is controlled by a dedicated microcontroller.

In some embodiments, each microcontroller 240 associated with each fixture 210 generates (or otherwise retrieves or access) a time delay interval. These time delay intervals may be a randomly generated intervals, for example randomly generated by each microcontroller thereby providing a set of uncorrelated time delay intervals for the set of fixtures. That is, according to some embodiments, there is a time delay interval generated for each specific fixture that is unique or uncorrelated with each of the other time delay intervals associated with each of the other fixtures. In these embodiments, each controller monitors the elapsed time (e.g., utilizing the internal clock). When the time delay interval has elapsed, the microcontroller signals and closes the switch/relay to the individual fixture and power from the mains flows directly to the individual fixture. In these embodiments, instead of all the LED lighting fixtures being simultaneously connected to the power mains, each fixture is energized at a slightly different time. This non-synchronized loading of the fixtures prevents a potentially damaging large transient in-rush current spike that would occur if power was simultaneously passed to each fixture. The fixtures do not appear as simultaneously loads on the system and a large in-rush current is prevented. The energizing of the fixtures may be “staggered in time”, and even though the time interval between when each fixture is energized is relatively small (e.g., 10-500 ms), the delay is sufficient to prevent the large transient in-rush currents that would manifest should the fixtures be energized simultaneously. The time delay intervals given are for examples only, and as will be evident to those skilled in the art, any number of different time delay intervals may be used that accomplish the limitation of inrush current. Furthermore, the ways and means used to compute a time delay interval and effect the switching are not limited to the examples provided, and many different approaches may be employed to accomplish embodiments of the disclosed invention as will be evident to those skilled in the art. Additionally, in some embodiments, a single controller may be used to generated uncorrelated time delays intervals and control multiple relays/switches.

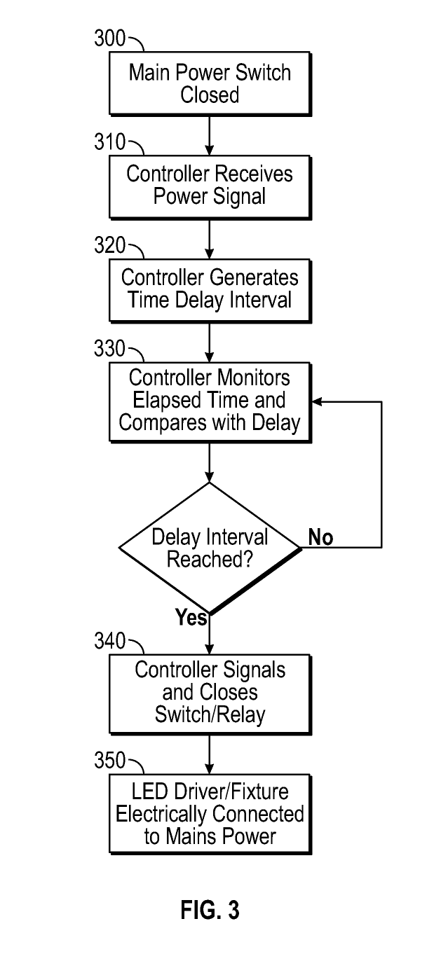

FIG. 3 shows a process flow according to some embodiments. The microcontroller receives a power signal 310; for example, the mains power switch is closed 300 and mains power is supplied to the microcontroller. Without limiting the invention in any way, in one embodiment, and AC-to-DC converter converts the input alternating current to output the appropriate direct current required by the microcontroller or processor. Other power conditioning steps may also be performed as desired or as necessary to provide the appropriate DC voltage and current to the microcontroller. Upon receiving the power signal, the processor (microcontroller) generates or accesses a time delay interval 320. In some embodiments the processor may be programmed to generate a random variable or number; in other embodiments, a look-up table may be accessed and preprogrammed or stored time delay interval retrieved; in still other embodiments, algorithms for computing a time delay interval may be programmed into the controller. The delay interval may be an absolute time duration such as 20 ms from receiving the power signal or alternatively may be a set number of processor clock cycles from receiving the power signal. Numerous ways of generating a delay interval will be recognized as possible by those skilled in the art. The controller monitors elapsed time to determine whether or not delay interval has been reached 330. At step 340 the time lapse equals the time interval delay (or the time delay interval has otherwise been completed), and the controller generates a signal to close the relay/switch 350 thereby connecting the light fixture power supply to the mains power line.

According to one embodiment, when the mains power switch is closed and the main circuit is energized the mains power ‘signal’ is received by the microcontroller. The microcontroller retrieves, computes or otherwise generates a time delay interval for an individual fixture load. In one embodiment, the controller generates a random number representing a time interval; in one example, this number may correspond to a number of processor clock cycles. The controller monitors the elapsed time (for example, elapsed clock cycles). When the time delay interval has elapsed, the controller closes the switch/relay. The closing of the switch allows main power to flow to the LED fixture. The control functionality outlined above may be implemented via software loaded onto the controller processor according to one embodiment. In some embodiments, the microcontroller, upon receiving the main power generates multiple uncorrelated time delay intervals, and at slightly differing times corresponding to the expiration of the different time delay intervals, closes multiple different relays/switches, each of which allows current to flow to a specific lighting fixture. According to these embodiments, the slight staggering in time of connecting the lighting fixture loads prevents or reduces inrush current spikes.

The delay for each fixture may be unique. In one embodiment, a microcontroller controls a switch on or associated with each LED fixture thereby controls when that particular fixture will be connected to the power mains (i.e., the time after the power main has been connected). The microcontroller may be programmed such that when main power is supplied, the microcontroller generates a time interval increment for closing the relay/switch associated with its particular fixture. For example, a unique or uncorrelated small delay (e.g., 10-500 ms or more) is generated by each microcontroller for each fixture such that when the power main switch is closed, each of fixtures are effectively switched on at slightly different or staggered times, based on the delay interval and switching functionality performed by the controller. In some embodiments, the delay, the time between when the mains power switch is closed and the time that the individual light fixture is energized, may be randomly generated.

The microcontroller may be powered by the mains power or alternatively may be powered by other means including by battery power. In one embodiment, a battery is utilized as backup power in case the main power is unavailable. The battery may be a rechargeable lithium ion or lithium polymer battery. In other embodiments, a supercapacitor may be is used for backup power.

To summarize, this embodiment provides a solution to limiting the in-rush current that would occur when a system of moderate to high power lighting fixtures are simultaneously connected to a power source. An in-rush limiting circuit element for each fixture comprises a programmable microcontroller and a relay/switch for providing a current path to the fixture. The microcontroller-switch combination effects a delay of passing current to each fixture when the power main is connected. The delay for each fixture may be independent of other fixtures and the energizing of the various fixture may be staggered and not occur simultaneously. Because each fixture has a slightly different delay or timing of relaying the AC mains power to the fixture, the inrush or spike current does not occur or is significantly attenuated. In some embodiments, some fixtures may share the same delay interval and will be energized simultaneously. For example, because in some embodiments each of the in-rush limiter for each fixture generates a time delay independently of other fixtures, the time delay intervals of two or more fixtures may be coincidently the same without in anyway limiting the invention.

In some embodiments each LED lighting fixture has its own in-rush current limiter (IRCL) module which connects to the LED driver PS unit of the fixture. In other embodiments, the IRCL is integrated into the power supply or driver itself. In other embodiments the IRCL module may not be integrated into the fixture and may be a stand-alone unit that can be incorporated into the main power circuit. In some embodiments, an IRCL module may be used to control multiple fixtures.

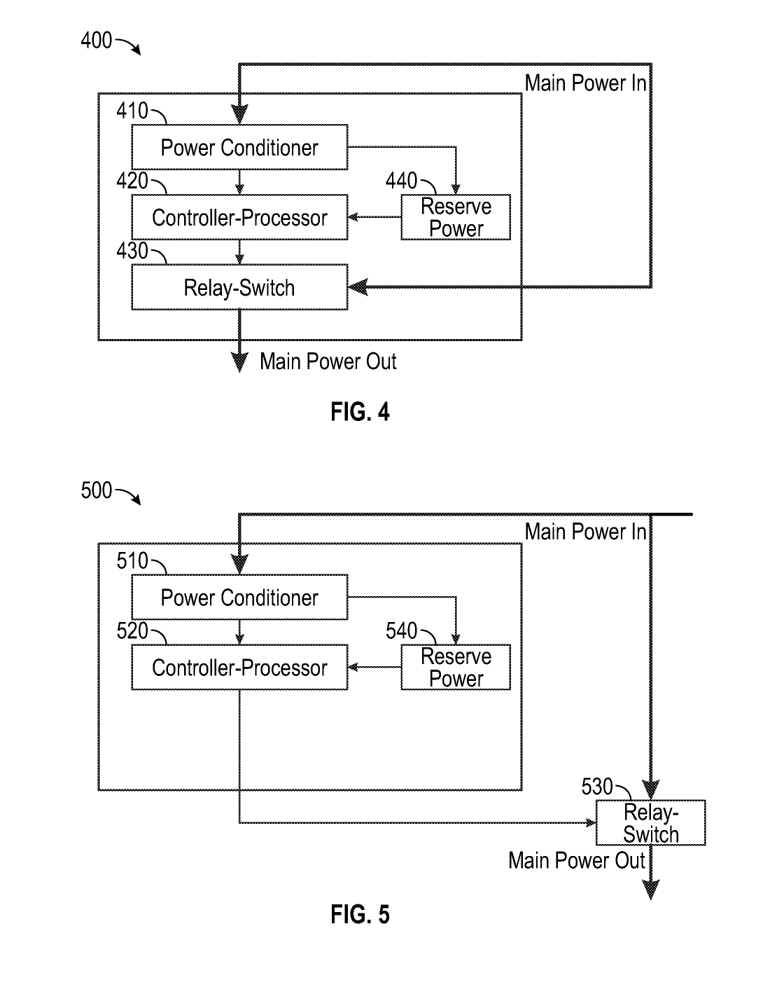

FIGS. 4 and 5 show a block diagram of an IRCL module according to some embodiments. In these examples, the IRCL module may be a standalone module and can be connected in-line with the LED driver power supply. Alternatively, the IRCL module may be incorporated into the power supply itself as a module. FIG. 4 shows a IRCL module 400 comprising an AC/DC converter or other power conditioner 410, a microcontroller or processor 420, a relay or other switching means 430 and a battery 440 for backup power. Main power enters the module via the Power Conditioner 410; the conditioned power is used by the microcontroller 420 and to control the relay/switch 430 according to some embodiments. Main power is also connected to the relay/switch (as shown in FIG. 2). When the controller closes the switch, main power flows through the switch to power the downstream load. A battery, or other back up energy source (e.g., capacitor) 440 is also included in some embodiments. The microcontroller may thereby operate in case of main power failure or when the main power is off. In some embodiments, when the main power is off or otherwise not provided, the microcontroller, operating off of the reserve power source, may set the relays or switches in open or closed positions. For example, when the mains power is lost (e.g., main switch is opened), the relays/switches 430 may in the closed position. The microcontroller, operating under reserve, may set the relays/switches to an open position in anticipation of the next main power on event.

FIG. 5 shows an IRCL module 500 comprising a power conditioner 510 a microcontroller or processor 520, and a reserve power source 540 for backup power according to some embodiments. In these embodiment, the a relay or other switching means 530 is external to the IRCL module. In some embodiments, the IRCL functionality described herein can be implemented as part of the LED driver power supply. For instance, the power conditioning, microcontroller functionality and associated switching can all be implemented as part of overall driver and power supply design. It will be evident to those skilled in the art that that microcontroller, relay/switch, power conditioning and other IRCL elements may all be placed on a single circuit board, or distributed separately or in various combinations and may also be included on the main board of the LED driver power supply in some embodiments.

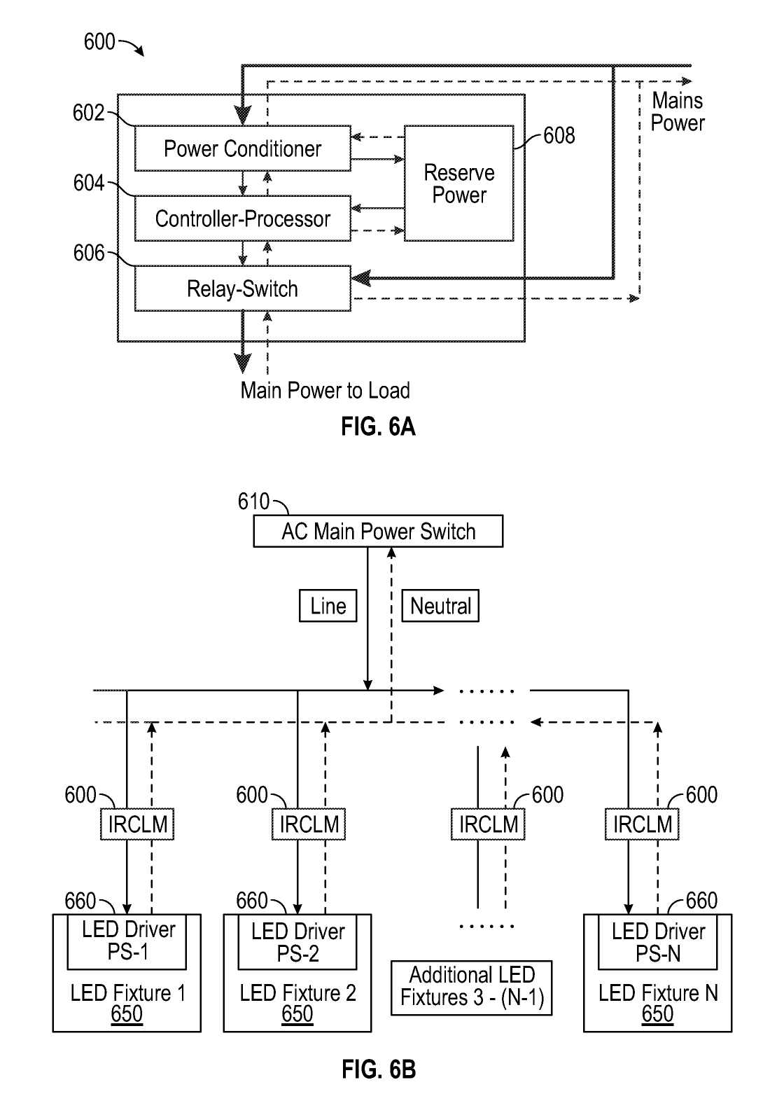

FIG. 6a shows a block diagram representing an inrush current lining module (IRCLM) 600 according to some embodiments. The IRCLM 600 comprises a power conditioner 602, a micro-controller or processor 604, a relay or switch 606 that is controlled by the microcontroller 604 and a source of reserve power 608, for example a rechargeable battery or ultra-capacitor. In some embodiments, when main power is not connected to the IRCML (e.g., the AC mains power is off), the relay or switch is the open state, that is, in a state which does not allow main power current to flow from the mains power through the relay or switch to energize a downstream load. The reserve power block 608 may supply needed power to the microcontroller when the AC main power is disconnected or otherwise when main power is lost or interrupted. When the main power (e.g., AC mains) is initially connected to the IRCLM, main power flows to the power conditioner 602, which conditions the power, for example via, inter alia, an AC/DC converter, which is then received by the microcontroller 604. The microcontroller 604 generates a time delay interval and at the expiration of the interval signals the relay or switch 606 thereby closing the relay or switch 606. When the switch 606 is closed, main power flows through the switch 606 downstream to the load.

FIG. 6b illustrates schematically a multi-load circuit, comprising LED grow light connected to an AC power mains that employ inrush current limiting modules (IRCLMs) 600 to prevent or mitigate inrush current spikes, according to some embodiments. Multiple LED grow light fixtures 650 that each comprise one or more LED drivers or power supplies 660 are electrically connected (e.g., through conductive wires) to a mains power switch 610. The mains power switch 610 provides connection to an AC power mains which is configured and provisioned to provide electrical power for the multiple LED grow fixture loads. Each electrical path from the AC mains switch 610 to an individual LED grow fixture comprises an IRCLM 600, for example as shown and described, with reference to FIG. 6a. The IRCLMs 600 are upstream from the grow light fixtures 650. When the AC main power switch 610 is closed, main power will flow to the IRCLMs, and as described elsewhere herein, each IRCLM will generate its own (uncorrelated and different from the other IRCLMs) time delay interval and activate its own relay or switch 606 at the end of that specific time delay interval thereby allowing main power to flow to the specific grow light fixture 660 downstream from the IRCLM. The mains power reaches each IRCLM at about the same time. However, because each IRCLM generates its own unique and uncorrelated time delay interval, and closes its respective switch at the end of that time delay interval thereby connecting its downstream LED fixture to the main power, each LED grow light fixture 650 is connected to the main power at a slightly different times thereby preventing a large inrush current. Operationally, because the LED grow light fixtures are not connected to the main power simultaneously, but rather each is connected at slightly different times (via the operation and functionality of the IRCLMs 600), system inrush current spikes are eliminated or significantly attenuated. Although the FIG. 6b, the IRCLMs 600 are shown separate and distinct from the grow light fixtures 650 and LED power supplies 660, this is only according to some embodiments. It is to be understood, and as will be evident to those skilled in the art, the IRCLM 600 may be incorporated into a power supply unit 660, or the LED fixture 650. In some embodiments an LED fixture 650 comprises an LED power supply 660 that also includes an IRCLM 600. Other embodiments of the invention include a power supply 660 comprising an IRCLM 600. In these embodiments, the IRCLM 800 is an integral component of the power supply 650. It should be understood that the diagrams herein illustrates some of the system components and connections between them and does not reflect specific structural relationships between components, and is not intended to illustrate every element of the overall system, but to provide illustration of the embodiment of the invention to those skilled in the art. Moreover, the illustration of a specific number of elements, such as LED drivers power supplies or LED fixtures is in no way limiting and the inventive concepts shown may be applied to a single LED driver or as many as desired as will be evident to one skilled in the art.

While the invention has been described with reference to exemplary embodiments, it will be understood by those skilled in the art that various changes may be made and equivalents may be substituted for elements thereof without departing from the scope of the invention. For example, embodiments of the invention are not limited to grow lights application or LED fixtures, but may be incorporated into any electrical systems which may benefit from limiting inrush current.

In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include many variants and embodiments. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc, are used to distinguish one element from another. Furthermore, the use of the terms a, an, etc. do not denote a limitation of quantity, but rather denote the presence of at least one of the referenced item.

What claimed is:

1. A method for limiting or attenuating inrush current spikes when simultaneously connecting multiple loads to a main electrical power source comprising the steps of:
receiving an electrical power signal at a first controller associated with a first load wherein said first controller controls a switching means for connecting said electrical power signal to said first load;
generating a first time delay; and
after the first time delay, activating a switching means for connecting the electrical power signal to the first load thereby electrically energizing the first load.

2. The method of claim 1 further comprising the steps of:
receiving said electrical power signal at a second controller associated with a second load wherein said second controller controls a switching means for connecting said electrical power signal to said second load;
generating a second time delay; and
after the second time delay, activating a switching means for connecting the electrical power signal to the second load thereby electrically energizing the second load.

3. The method of claim 1 wherein said first controller generates said time delay upon receiving said electrical power signal, compares said time delay to an elapsed time, determines when said first time delay has completed and activates said switching means to electrically energize said first load.

4. The method of claim 1 further comprising the steps of:
generating a second time delay and third time delay associated with a second load and a third load respectively; and
after the second time delay, activating a switching means for connecting said electrical power signal to a second load thereby electrically energizing the second load and after the third time delay activating a switching means for connecting the electrical power signal to a third load thereby electrically energizing the third load wherein said first controller generates said second and third time delays upon receiving said electrical power signal, compares said time delays to an elapsed time, determines when said second and third time delays have completed and activates said switching means to electrically energize said second and third loads.

5. The method of claim 1 wherein said time delay is randomly generated by the controller.

6. The method of claim 1 wherein said time delay interval is less than about 200 ms.

7. The method of claim 1 wherein the first time delay is different than said second time delay.

8. The method of claim 1 wherein the switching means comprises an electrical relay and the electrical power signal is delivered by the AC power mains.

9. The method of claim 2 wherein said first and second loads comprises LED grow light fixtures.

10. The method of claim 1 wherein the first load comprises DC power supply and the power supply comprises said first controller.

11. The method of claim 4 wherein the first time delay, the second time delay and the third time delay are uncorrelated to one another and each of said time delays is different from each of the other time delays.

12. The method of claim 4 wherein the loads comprise LED grow lights and the power source is the AC mains.

13. A circuit element for connecting an electrical power signal to a load while limiting or attenuating inrush or current spikes to the load comprising:
a power conditioner;
electrical switching means for connecting an electrical power signal to a load;
a microcontroller that, upon receiving an electrical power signal, generates a time delay interval, and at the end of the time delay interval controls the electrical switching means to connect the electrical power signal to the load thereby electrically energizing the load; and
a reserve power means for providing electrical power to the microcontroller.

14. The circuit element of claim 13 wherein the electrical switching means comprises an electrical relay or solid state switch.

15. The circuit element of claim 13 wherein the microcontroller is programmable and wherein the microcontroller generates random time delay intervals upon receiving the electrical power signal.

16. The circuit element of claim 13 wherein the reserve power source comprises a rechargeable battery or an ultra capacitor.

17. A DC power supply with integrated switching means operable to limit or attenuate inrush current spikes when connecting the power supply to main power comprising:
an input means for receiving electrical power;
a power conditioner;
a logic controlled switching mechanism for delaying when main electrical power, received via said input means, is connected to the portion of the power supply downstream from said switching mechanism; and
an output means for delivering conditioned power to a downstream electrical load.

18. The power supply of claim 17 wherein the logic controlled switching means comprises a programmable microcontroller that initially delays connecting received main electrical power to the downstream portion of the power supply by generating a time delay interval upon receiving the main electrical power, waiting for a time period equal to the time delay interval, and then operating a switching means to connect the received main power to the downstream portion of the power supply.

19. The power supply of claim 18 wherein the logic controlled switching means further comprises an electrical relay or solid state switch.

20. The power supply of claim 17 wherein the power supply further comprises a reserve power means for operating said microcontroller in the absence of main power, and the power conditioner comprises and AC/DC converter.
